(19) United States
(12) Patent Application Publication
(10) Pub. No.: US 2019/0275614 A1
(43) Pub. Date: Sep. 12, 2019

(54) SHAPING METHOD USING ADDITIVELY SHAPING DEVICE AND ADDITIVELY SHAPING DEVICE

(71) Applicant: JTEKT CORPORATION, Osaka-shi (JP)

(72) Inventors: Yoshinori IMOTO, Kariya-shi (JP); Koichi SHIIBA, Nisshin-shi (JP)

(73) Assignee: JTEKT CORPORATION, Osaka-shi (JP)

(21) Appl. No.: 16/293,720

(22) Filed: Mar. 6, 2019

(30) Foreign Application Priority Data
Mar. 7, 2018 (JP) 2018-040989

(51) Int. Cl. B23K 26/354; B33Y 10/00; B33Y 30/00; B23K 26/34

(52) U.S. Cl. CPC B23K 26/354; B23K 26/34; B33Y 30/00; B33Y 10/00

(57) ABSTRACT

A shaping method using an additively shaping device is a shaping method of additively shaping a shaped article by melting metal powder through irradiation of a shaping optical beam and then solidifying the melted metal powder. The shaping method includes: a first step of preparing, in an irradiation area on a baseplate, a first layer of the shaped article having on an upper surface of the first layer a trough portion that is formed in a recessed manner along a predetermined axis; a second step of feeding the metal powder to the trough portion; and a third step of, after the process of the second step, applying the shaping optical beam to the metal powder fed to the trough portion to melt the metal powder.

### INCORPORATION BY REFERENCE

The disclosure of Japanese Patent Application No. 2018-040989 filed on Mar. 7, 2018 including the specification, drawings and abstract, is incorporated herein by reference in its entirety.

### BACKGROUND OF THE INVENTION

### 1. Field of the Invention

The present invention relates to a shaping method using an additively shaping device and the additively shaping device.

### 2. Description of Related Art

Recently, as described in Japanese Patent Application Publication No. 2003-129862, development of metal additive manufacturing (AM) has been active that involves sintering or melting powdery metal through laser beam irradiation and then solidifying the sintered or melted metal, and stacking the solidified layers one after another to manufacture a three-dimensionally shaped article. Examples of the metal used for the metal AM include maraging steel, stainless steel, titanium steel, copper, and aluminum. Among them, copper and aluminum are in high demand.

However, absorptance, in copper and aluminum, of a laser beam having a near-infrared wavelength that is commonly used in metal AM is generally low. Thus, temperature increase of copper or aluminum irradiated with a laser beam of a near-infrared wavelength is slow, which requires much time for melting, thereby making it difficult to form a penetrating portion in a member serving as a base. Furthermore, copper and aluminum both have higher heat conductivity than, for example, iron has. Thus, even if copper and aluminum have melted, once irradiation of a laser beam is stopped, heat in a melted portion is quickly transmitted to surrounding copper or aluminum, whereby the temperature of the melted portion is significantly reduced. Due to this temperature reduction, surface tension of the melted portion increases. Consequently, near the melting point, the increased surface tension due to the temperature reduction may cause copper and aluminum in a molten state to form a discontinuous ball (spherical) shape to be solidified.

Furthermore, even if a favorably solidified bead portion has been successfully formed, when a laser beam is applied by a conventional method in order to form a new bead portion such that the new bead portion widely overlaps the favorably solidified bead portion, heat is transmitted also to bead portions that have been already formed. At this time, the already formed bead portions do not have favorable penetrating portions, and thus may be melted again, and then may be solidified into a discontinuous ball (spherical) shape due to their surface tension. Consequently, the density of the shaped article decreases, and desired physical properties cannot be obtained.

### SUMMARY OF THE INVENTION

One object of the present invention is to provide a shaping method using an additively shaping device that enables production of an additively shaped article having high density and favorable physical properties even with any material, and to provide the additively shaping device.

A shaping method using an additively shaping device according to one aspect of the present invention is a shaping method of additively shaping a shaped article by melting metal powder through irradiation with a shaping optical beam and then solidifying the melted metal powder. The additively shaping device includes: a metal-powder feeding device that feeds the metal powder to an irradiation area of the shaping optical beam; and a shaping-optical-beam irradiation device that applies the shaping optical beam to a predetermined position of the metal powder fed to the irradiation area while being isolated from outside air. The shaping method includes: a first step of preparing, in the irradiation area on a baseplate, a first layer of the shaped article having on an upper surface of the first layer a trough portion that is formed in a recessed manner along a predetermined axis; a second step of feeding the metal powder to the trough portion; and a third step of, after the second step, applying the shaping optical beam to the metal powder fed to the trough portion to melt the metal powder.

As described above, in the first step, the first layer of the shaped article having the trough portion formed in a recessed manner on the upper surface of the first layer is prepared. In the second step, the metal powder is fed to the trough portion, and in the third step, the shaping optical beam is applied to the metal powder in the trough portion to melt the metal powder. In other words, the metal powder in the trough portion irradiated with the shaping optical beam is melted in the trough portion, and is stored in the trough portion. Thus, even later when heat of the melted metal stored in the trough portion is transmitted to outside due to its high heat conductivity, and accordingly the temperature of the melted metal decreases significantly and the surface tension of the melted material increases, the melted metal is less likely to form a ball (spherical) shape, and high density can be obtained after solidification.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram of an additively shaping device according to a first embodiment;

FIG. 2 is a graph illustrating a relationship between wavelength and absorptance of a near-infrared laser beam for each metal material;

FIG. 3 is a top view of a metal-powder feeding device in FIG. 1;

FIG. 4 is a diagram for explaining a configuration of a laser head;

FIG. 5 is a diagram for explaining an irradiation path H;

FIG. 6 is a flowchart 1 of an additively shaping method according to the first embodiment;

FIG. 7 is a perspective view of beads;

FIG. 8 is a diagram of FIG. 7 when viewed from a Q-direction;

FIG. 9 is a diagram for explaining the shape of a bead;

FIG. 10 is a diagram of a state in which a thin film layer 15b is fed to a first layer;

FIG. 11 is a diagram illustrating a state of FIG. 10 after a near-infrared laser beam is applied to trough portions;

FIG. 12 is a diagram for explaining a state in which the irradiation path H is rotated by 90 degrees;

FIG. 13 is a diagram of a stacked state of an additively shaped article according to modification 2 of the first embodiment;

FIG. 14 is a diagram of a stacked state of an additively shaped article according to modification 3 of the first embodiment;

FIG. 15 is a flowchart 2 of an additively shaping method according to a second embodiment;

FIG. 16 is a diagram illustrating a state in which trough portions are formed on a surface of a baseplate in the second embodiment; and

FIG. 17 is a schematic diagram of an additively shaping device according to a third embodiment.

### DETAILED DESCRIPTION OF EMBODIMENTS

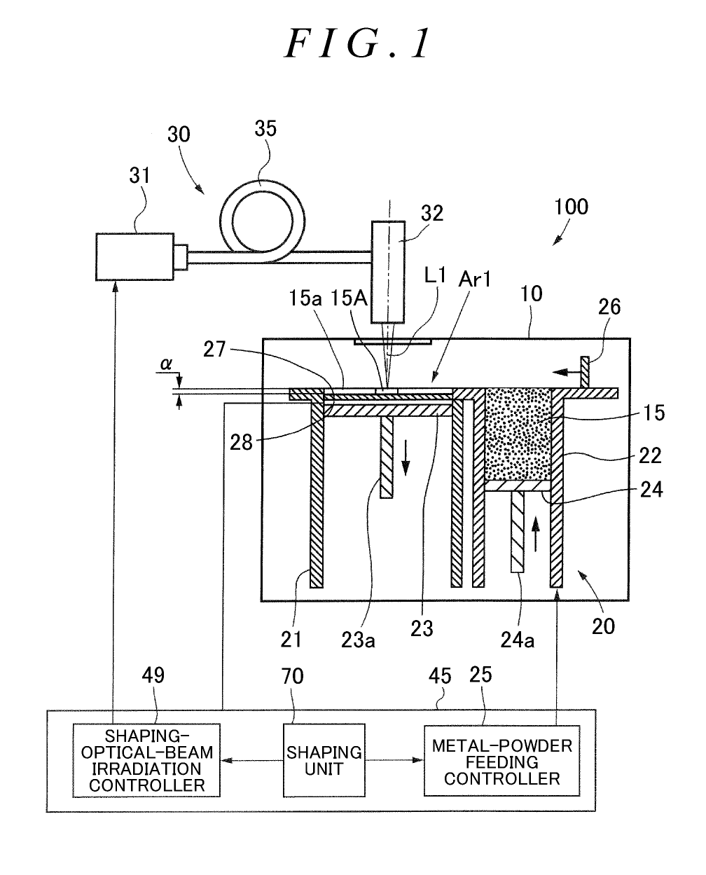

An outline of an additively shaping device 100 (see FIG. 1) according to a first embodiment of the present invention will be described first. The additively shaping device 100 is a device that additively shapes a shaped article by melting, through irradiation with a shaping optical beam, metal powder fed to an irradiation area and then solidifying the melted metal powder on a layer-by-layer basis.

The present embodiment will be described in which a laser beam of a near-infrared wavelength that is inexpensive is used as the shaping optical beam. Hereinafter, the laser beam of a near-infrared wavelength is called a near-infrared laser beam L1. However, the present invention is not limited to this. The near-infrared laser beam L1 is merely an example, and not only the laser beam of a near-infrared wavelength (near-infrared laser beam L1), but also a CO₂ laser (far-infrared laser beam) or a semiconductor laser may be used as the shaping optical beam.

In the present embodiment, as a metal powder that is a raw material of a shaped article, copper powder (Cu) that is highly demanded in the market is used as one example among various metal materials that can be used. In the present embodiment, copper powder (Cu) is fed onto an upper surface of a flat baseplate 27 made of copper and that forms a lowermost layer portion (base portion) of a shaped article. Copper is a low-absorptance material that has an absorptance of the near-infrared laser beam L1 equal to or lower than a predetermined value at room temperature.

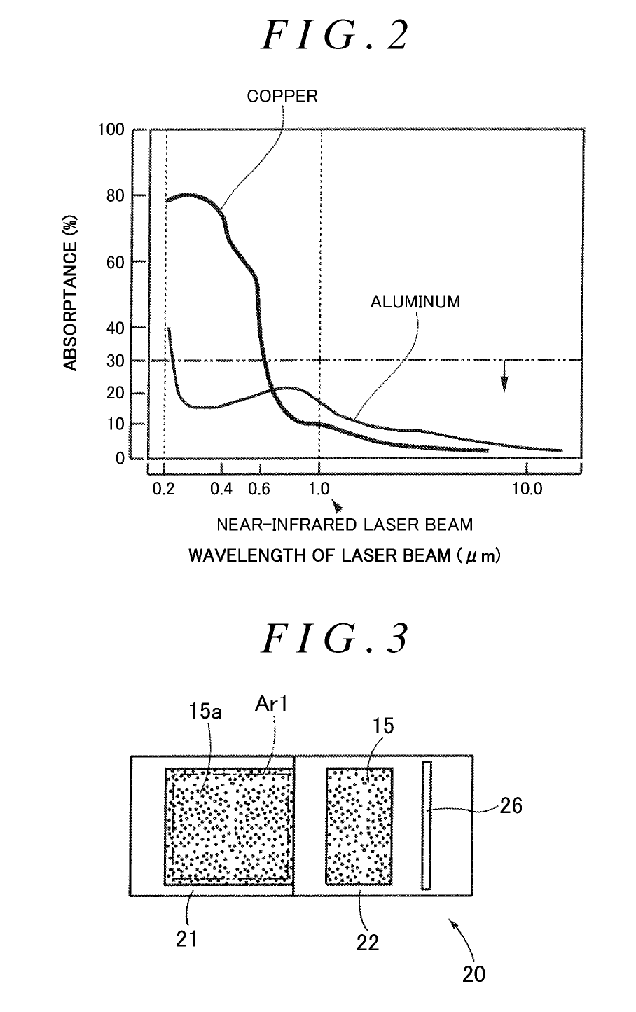

The expression “equal to or lower than a predetermined value” herein means being equal to or lower than 30%, for example. As depicted in FIG. 2, the absorptance of the near-infrared laser beam L1 in copper is about 10% (that is, equal to or lower than 30%). Thus, when the above-described copper powder (metal powder) is irradiated with the near-infrared laser beam L1 to be melted by an additively shaping method of the related art, it takes a long time for the temperature of the copper powder to reach the melting point because of the low absorptance of the near-infrared laser beam L1. Also in this case, the baseplate 27 (see FIG. 1) is made of copper, in which the absorptance of the near-infrared laser beam L1 is low and the heat capacity of which is high. Thus, like the copper powder, the baseplate 27 does not easily rise in temperature and does not easily melt even when the near-infrared laser beam L1 is applied to the copper powder fed onto the upper surface of the baseplate 27.

Copper is a metal having a heat conductivity (about 400 W/m·K) higher than the heat conductivity (about 80 W/m·K) of iron, for example, and also having a relatively high melting point (about 1080° C.). Because of these properties, when copper powder (metal powder) is irradiated with the near-infrared laser beam L1 by the additively shaping method of the related art, and when the temperature of the copper powder reaches the melting point to melt the copper powder and irradiation of the near-infrared laser beam L1 is stopped, heat of the melted copper flows outside through an unmelted portion such as the baseplate 27 that is in contact therewith. Thus, the temperature of the melted copper decreases by a predetermined amount in a short time while maintaining its molten state (liquid state). At this time, because penetration is not formed in the baseplate 27 as described above, the melted copper and the baseplate 27 are not connected completely.

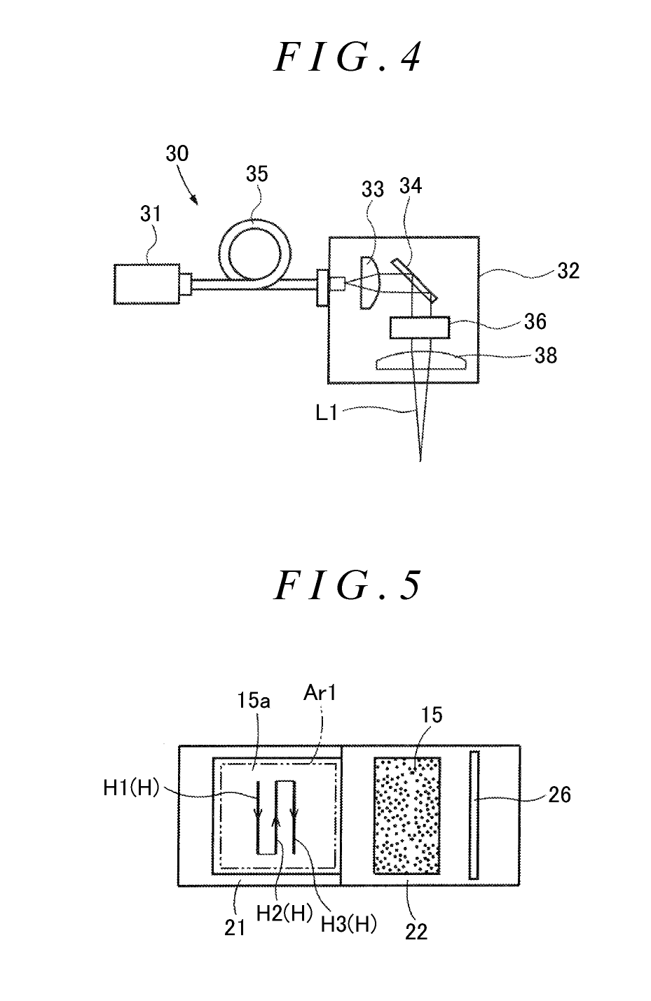

It is known that the surface tension γ of metal in a liquid state near the melting point tends to be greater for material having a higher melting point (see FIG. 4 in Shiro Kohara, “Interface in Metal Matrix Composites and Wettability”, Bulletin of the Japan Institute of Metals, Volume 14, Issue 8). Thus, a relatively high surface tension γ is created in copper in a molten state (liquid state) due to its high melting point. Thus, after the temperature of copper maintaining the molten state (liquid state) decreases by a predetermined amount, its great surface tension γ (not depicted) may cause the copper to form a discontinuous distorted ball shape, and to be solidified.

Even if copper in a molten state (liquid state) has been solidified without forming a ball shape, the copper forms a new solidified portion. Thus, when a laser beam is applied thereto by the conventional method such that this new solidified portion widely overlaps the solidified portion thus favorably solidified, heat is transmitted also to solidified portions that have been already formed. At this time, the already formed solidified portions do not have favorable penetrating portions, and thus may be melted again due to heat transmission, and then may be solidified into a discontinuous ball (spherical) shape due to the surface tension γ.

As described above, it is difficult to solidify copper while maintaining its molten state (liquid state). In other words, it is difficult to form a continuous linear solidified portion that is formed while maintaining its molten state (liquid state). Thus, it is difficult to manufacture additively shaped articles having high density. In view of this, the inventers of the present invention conducted experiments and studies, and have invented an additively shaping method and an additively shaping device that, even when using copper powder (metal powder) having properties described above as material for additively shaped articles, and when the copper powder is melted, cooled, and solidified, makes it possible to obtain solidified portions (beads) each of which is not formed in a discontinuous distorted ball shape but is formed in a linear and continuous shape, and to consequently form additively shaped articles having high density. Details will be described hereinafter.

The additively shaping device 100 according to the present invention will be described first. FIG. 1 is a schematic diagram of the additively shaping device 100 according to the first embodiment of the present invention. The additively shaping device 100 includes a chamber 10, a metal-powder feeding device 20, a shaping-optical-beam irradiation device 30, and a control device 45. The control device 45 includes a metal-powder feeding controller 25, a shaping-optical-beam irradiation controller 49, and a shaping unit 70.

The chamber 10 is a casing formed in a substantially rectangular parallelepiped shape, and is a container capable of isolating inside air from outside air. The chamber 10 includes a device (not depicted) that can replace the air inside the chamber with an inert gas such as helium, nitrogen, and argon. Alternatively, instead of replacing inside air with an inert gas, the chamber 10 may be configured so that inside of the chamber can be depressurized by suctioning inside air to make substantially a vacuum state.

The metal-powder feeding device 20 is provided inside the chamber 10. The metal-powder feeding device 20 is controlled by the metal-powder feeding controller 25 of the control device 45, and feeds metal powder 15 that is a raw material of an additively shaped article to an irradiation area Ar1 (see FIG. 3) for the near-infrared laser beam L1 (corresponding to the shaping optical beam). The metal powder 15 is powder of copper as described above.

As depicted in FIG. 1 and FIG. 3, the metal-powder feeding device 20 includes a shaping container 21 and a powder storing container 22. As depicted in FIG. 1, a shaped-article lifting table 23 is provided inside the shaping container 21. A baseplate 27 made of copper is disposed on the shaped-article lifting table 23. The metal-powder feeding device 20 feeds a thin film layer 15a of the metal powder 15 (Cu) that is a base of a first layer 15A of a shaped article described later onto the irradiation area Ar1 on the baseplate 27. The shaping-optical-beam irradiation controller 49 causes the near-infrared laser beam L1 to be applied to the thin film layer 15a on the basis of a predetermined application pattern, whereby the first layer 15A is formed (prepared).

A method of feeding the thin film layer 15a onto the irradiation area Ar1 and the application pattern of the near-infrared laser beam L1 to the first layer 15A for forming the thin film layer 15a, for example, will be described later in detail, and thus are described here only briefly. A heater 28 is provided under the baseplate 27, that is, on the side opposite to the side thereof irradiated with the near-infrared laser beam L1 (shaping optical beam). The heater 28 is connected to the control device 45 and controlled by the control device 45 to heat (preheats) the thin film layer 15a via the baseplate 27 before the first layer 15A is formed. The thin film layer 15a is heated with the heater 28 to about 400° C., for example. The heater 28 may be in any form.

Although not depicted, the heater 28 may be disposed on the side irradiated with the near-infrared laser beam L1 to heat the thin film layer 15a. Alternatively, the heater 28 may be omitted, and the near-infrared laser beam L1 may be applied to respective portions of the thin film layer 15a that are irrelevant to formation of a shaped article to heat the entire thin film layer 15a. In this case, irradiation output of the near-infrared laser beam L1 only needs to be set to a low output so as not to melt the copper powder of the thin film layer 15a.

When the first layer 15A has been formed on the irradiation area Ar1, the metal-powder feeding device 20 is controlled by the metal-powder feeding controller 25 of the control device 45, whereby the shaped-article lifting table 23 is moved downward. The metal-powder feeding device 20 is then activated to feed a thin film layer 15b of the metal powder 15 (Cu) at a predetermined thickness h described later onto the first layer 15A (first time). Subsequently, the near-infrared laser beam L1 is applied again to the thin film layer 15b, whereby part of the thin film layer 15b is melted and is then solidified to form a second layer 15B. A method of feeding the thin film layer 15b onto the irradiation area Ar1 and the application pattern of the near-infrared laser beam L1 to the thin film layer 15b for forming the second layer 15B, for example, will be described later in detail, and thus are described here only briefly.

When the second layer 15B has been formed, the metal-powder feeding device 20 is controlled by the metal-powder feeding controller 25, whereby the shaped-article lifting table 23 is moved downward by a predetermined height. In the same manner as described above, the metal powder 15 (thin film layer 15a) is fed onto the second layer 15B on the shaped-article lifting table 23. Subsequently, the near-infrared laser beam L1 is applied again onto the thin film layer 15a, whereby a predetermined position of the thin film layer 15a is melted, and is then solidified to form a first layer 15A (second time) again. At this time, an orientation in which the first layer 15A (first time) is disposed and the orientation in which the first layer 15A (second time) is disposed are different by an optional angle, which will be described later in detail. Subsequently, a second layer 15B is formed again on the first layer 15A (second time). These operations are repeated, whereby a desired additively shaped article extending upward is formed.

In the powder storing container 22, the metal powder 15 is stored on the feeding table 24, and the feeding table 24 is moved upward, whereby the metal powder 15 protrudes upward by a predetermined height to be fed. Support shafts 23a and 24a are attached to the shaped-article lifting table 23 and the feeding table 24, respectively. The support shafts 23a and 24a are connected to a driving device (not depicted) that is controlled by the control device 45, and are moved up and down by the operation of the driving device.

The metal-powder feeding device 20 is provided with a recoater 26 that moves across all areas of the respective openings of the shaping container 21 and the powder storing container 22. The recoater 26 is moved from the right to the left in FIG. 1 and FIG. 3. With this movement, the metal powder 15 fed by upward movement of the feeding table 24 is conveyed onto the shaped-article lifting table 23, whereby thin film layers 15a and 15b are formed on the shaped-article lifting table 23. At this time, the thicknesses of the thin film layers 15a and 15b depend on the amount of the downward movement of the shaped-article lifting table 23. In the present embodiment, the thicknesses of the thin film layers 15a and 15b are set so as to correspond to the first layer 15A and the second layer 15B, respectively. Details will be described later.

The shaping-optical-beam irradiation device 30 is a device that applies the near-infrared laser beam L1 to predetermined positions on surfaces of the thin film layers 15a and 15b of the metal powder 15 fed to the irradiation area Ar1 (see FIG. 1 and FIG. 3) in the chamber 10 by the metal-powder feeding device 20 while being isolated from outside air. The shaping-optical-beam irradiation device 30 is controlled by the shaping-optical-beam irradiation controller 49 of the control device 45. As depicted in FIG. 1, the shaping-optical-beam irradiation device 30 includes a laser oscillator 31 and a laser head 32. The laser oscillator 31 includes an optical fiber 35 for transmitting a near-infrared laser beam L1 caused to oscillate by the laser oscillator 31 to the laser head 32.

The laser oscillator 31 generates the near-infrared laser beam L1, which is a continuous-wave (CW) laser beam, by oscillating such that the wavelength becomes a predetermined near-infrared wavelength set in advance. Specifically, as the near-infrared laser beam L1, HoYAG (wavelength: about 1.5 μm), yttrium vanadate (YVO, wavelength: about 1.06 μm), and ytterbium (Yb, wavelength: about 1.09 μm), for example, can be used. Thus, the laser oscillator 31 can be produced inexpensively, and also can be operated inexpensively because of its low energy consumption.

As depicted in FIG. 1, the laser head 32 is disposed at a predetermined distance apart from the surface of the thin film layer 15a in the chamber 10. As depicted in FIG. 4, the laser head 32 includes a collimating lens 33, a mirror 34, a galvanometer scanner 36, and an fθ lens 38. The collimating lens 33, the mirror 34, the galvanometer scanner 36, and the fθ lens 38 are disposed in a casing of the laser head 32. The collimating lens 33 collimates the near-infrared laser beam L1 emitted from the optical fiber 35 into parallel rays.

The mirror 34 changes the traveling direction of the near-infrared laser beam L1 thus collimated such that the near-infrared laser beam L1 enters the galvanometer scanner 36. In the present embodiment, the mirror 34 changes the traveling direction of the near-infrared laser beam L1 by 90 degrees.

The galvanometer scanner 36 changes the traveling direction of the near-infrared laser beam L1 such that the near-infrared laser beam L1 is applied through the fθ lens 38 to predetermined positions of surfaces of the thin film layers 15a and 159b. In other words, the laser head 32 can, using the galvanometer scanner 36, flexibly change the application angle of the near-infrared laser beam L1 caused to oscillate by the laser oscillator 31.

As the galvanometer scanner 36, for example, a common scanner is used that includes a pair of movable mirrors (not depicted) that can move in an oscillating manner in two directions orthogonal to each other. The fθ lens 38 is a lens that concentrates the collimated near-infrared laser beam L1 incident from the galvanometer scanner 36. The near-infrared laser beam L1 emitted from the laser head 32 is emitted into the chamber 10 through a transparent glass or resin provided to an upper surface of the chamber 10. The near-infrared laser beam L1 used in the above description is produced by a YAG laser.

The shaping unit 70 controls operation of the shaping-optical-beam irradiation device 30 via the shaping-optical-beam irradiation controller 49. The shaping unit 70 causes the shaping-optical-beam irradiation device 30 to apply the near-infrared laser beam L1 (shaping optical beam) to the thin film layer 15a along an irradiation path H (see FIG. 5) set on a surface of the thin film layer 15a fed to the irradiation area Ar1. The irradiation path H will be described later in detail.

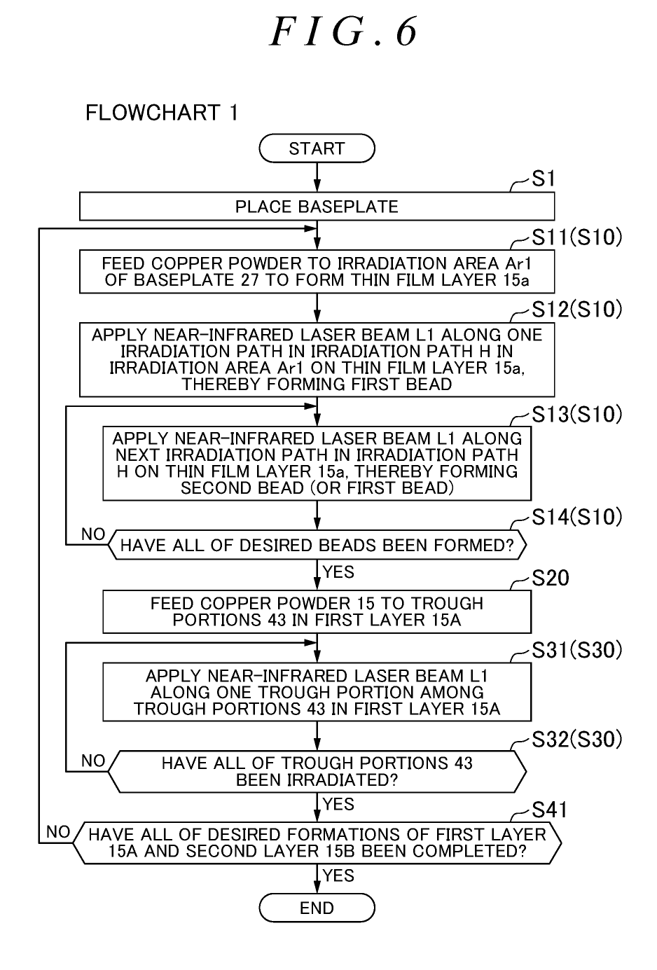

The following describes an additively shaping method according to the present invention with reference to the flowchart 1 in FIG. 6. The shaping method is a method using the additively shaping device 100 for forming a shaped article by melting part of thin film layers 15a and 15b through irradiation of the near-infrared laser beam L1, and then solidifying and stacking the melted layers. The shaping method includes a first step S10, a second step S20, and a third step S30.

The first step S10 is a step of preparing, in the irradiation area Ar1 (see FIG. 3) on the baseplate 27, a first layer 15A of a shaped article having, on its upper surface, trough portions 43 that are formed in a recessed manner along the irradiation path H (predetermined axis) described later.

The second step S20 is a step of feeding copper powder (metal powder) to the trough portions 43. The third step S30 is a step of, after performing the second step S20, applying the near-infrared laser beam L1 (shaping optical beam) to the copper powder 15 (metal powder) fed to the trough portion 43 to melt the copper powder, and solidifying the melted copper powder. The first step S10 includes a first feeding step S11, a first laser irradiation step S12, and a second laser irradiation step S13. The respective steps S11, S12, and S13 will be described in the following flowchart in detail.

The preparation step will be described first. To begin with, the metal powder 15 is charged into the powder storing container 22. Subsequently, air inside the chamber 10 of the additively shaping device 100 is replaced with nitrogen gas, for example, by a gas replacement device (not depicted).

In a preliminary step S1, a baseplate 27 is placed on the shaped-article lifting table 23. At this time, as depicted in FIG. 1, the height of the shaped-article lifting table 23 is adjusted by the metal-powder feeding controller 25 (control device 45) such that the upper surface of the baseplate 27 is positioned below the upper surface of the shaping container 21 by the thickness of the first layer 15A. As described above, the baseplate 27 is a plate member made of copper (Cu). The baseplate 27 is also a base member that is cut off by machining after a shaped article (additively shaped article) is formed on the baseplate 27.

The heater 28 is provided between the baseplate 27 and the upper surface of the shaped-article lifting table 23. The heater 28 is controlled by the control device 45 to heat the baseplate 27. Thus, the upper surface of the baseplate 27 is maintained at about 400° C.

Subsequently, in the first feeding step S11 (first step S10), copper powder (metal powder) is fed to the irradiation area Ar1 on the baseplate 27. For this step, to begin with, the metal-powder feeding controller 25 causes the metal-powder feeding device 20 to move the feeding table 24 carrying the metal powder 15 upward, thereby causing the metal powder to protrude from the upper surface of the powder storing container 22 by a predetermined height (not depicted).

Subsequently, the recoater 26 is moved from the right to the left in FIG. 1, whereby the copper powder 15 (metal powder) is fed from the powder storing container 22 to the shaping container 21 to form a thin film layer 15a of the copper powder having a thickness cc on the baseplate 27 as depicted in FIG. 1. The thin film layer 15a is then heated at about 400° C., for example, by the heater 28 via the baseplate 27.

In the first laser irradiation step S12 (first step S10), the shaping unit 70 controls the shaping-optical-beam irradiation device 30 to cause the shaping-optical-beam irradiation device 30 to apply the near-infrared laser beam L1 (shaping optical beam) to the surface of the thin film layer 15a fed to the irradiation area Ar1 on the baseplate 27 along H1 of the irradiation path H set on the surface as depicted in FIG. 5.

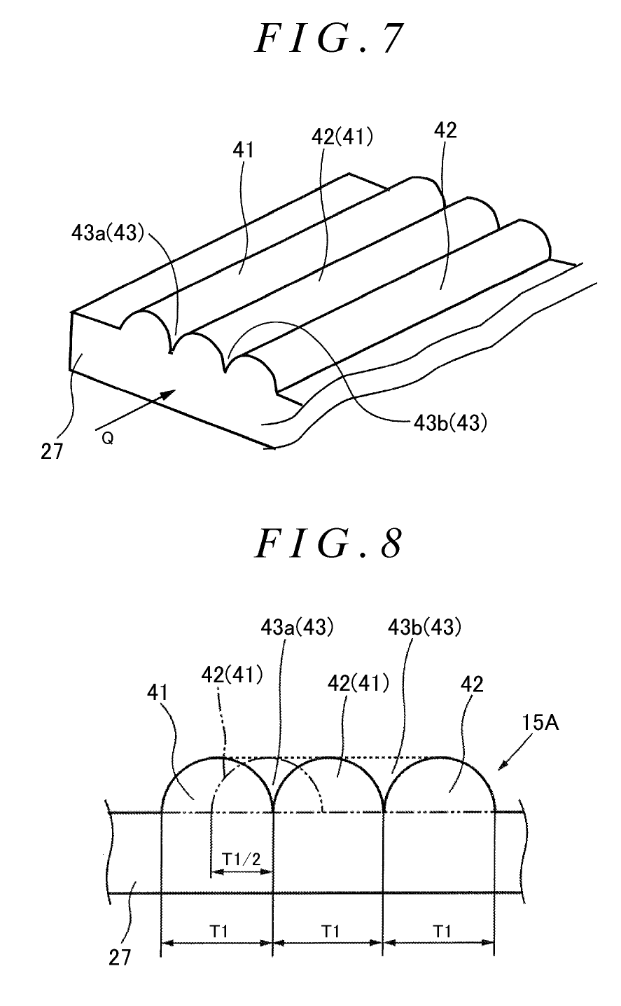

The copper powder of the thin film layer 15a is heated to be melted by this step, and is then solidified, whereby a first bead 41 (on the left side in FIG. 7 and FIG. 8) is formed that linearly extends in the direction of the predetermined axis and has a semicircular shape in its cross-section intersecting the predetermined axis. At this time, the first bead 41 can be more stably formed by having been heated at about 400° C. by the heater 28. A second bead 42 described later is formed in the same manner as described above. Herein, the copper powder 15 remains on portions other than the portion on which the first bead 41 is formed.

As depicted in FIG. 5, the above-described irradiation path H includes irradiation paths H1, H2, . . . , Hn that are parallel to each other. The irradiation paths H1, H2, Hn each correspond to the predetermined axis. In the present embodiment, Hn is expressed as H3 for convenience of description. In the present embodiment, the diameter ϕd (not depicted) of a spot irradiated with the near-infrared laser beam L1 on the surface of the thin film layer 15a is about ϕ80 μm to ϕ100 μm, for example. However, this is merely one example, and this spot diameter ϕd may be set optionally.

As described above, the first bead 41 is formed so as to linearly extend in the direction of the predetermined axis and have a semicircular shape in its cross-section intersecting the predetermined axis (see FIG. 8). In the related art, such beads (solidified portions) are generally formed so as to each have a downward protruding shape. By contrast, in the present invention, the beads are formed so as to each have an upward protruding semicircular shape (protruding shape). This feature is significantly different from the related art.

Subsequently, in the second laser irradiation step S13 (first step S10), the shaping unit 70 controls the shaping-optical-beam irradiation device 30 to cause the shaping-optical-beam irradiation device 30 to apply the near-infrared laser beam L1 (shaping optical beam) to the thin film layer 15a along the irradiation path H2 thereon (i.e., the irradiation path H (H2) adjacent to the irradiation path H (H1) that has just been irradiated) depicted in FIG. 5. By this application, the copper powder 15 on the irradiation path H2 is heated to be melted, and is then solidified, whereby the second bead 42 described above (see the middle bead 42 (41) in FIG. 7 and FIG. 8) is formed at a predetermined distance apart from the first bead 41. The second bead 42 (41) linearly extends in the extending direction of the irradiation path H2 (direction of the predetermined axis) and has a semicircular shape in its cross-section intersecting the irradiation path H2 (the predetermined axis).

The cross-sectional shape of this middle second bead 42 is the same as the cross-sectional shape of the first bead 41. In a space between the first bead 41 and the second bead 42, a trough portion 43 (in the following description, the trough portion that has been initially formed is called “trough portion 43a” for convenience of description) is formed (defined). At this time, the first bead 41 and the second bead 42 are preferably arranged with a distance therebetween such that their base portions are in contact with each other as depicted in FIG. 8. However, the present invention is not limited to this, and as indicated by the long dashed double-short dashed lines in FIG. 8, when the widths of base portions of the first bead 41 and the second bead 42 are T1 and T1, respectively, the first bead 41 and the second bead 42 may be arranged so as to overlap each other by T1/2. Alternatively, the first bead 41 and the second bead 42 may be arranged such that their base portions are not in contact with each other and are spaced apart (not depicted).

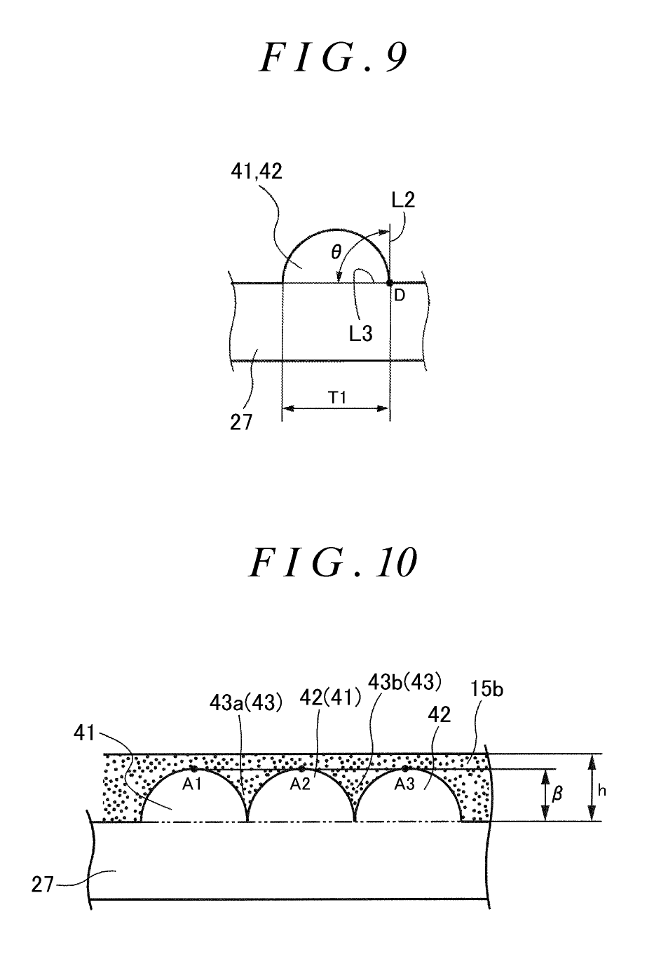

Each of the first bead 41 and the second bead 42 preferably has a semicircular shape (protruding shape) in its cross-sectional shape (see FIG. 9) having a contact angle θ equal to or less than 90°. The contact angle θ herein means an angle formed by a tangent line L2 and a boundary L3 between the first bead 41 (second bead 42) and the baseplate 27. The tangent line L2 is a tangent to a surface of the first bead 41 (second bead 42) at a point D where the first bead 41 (second bead 42) and the baseplate 27 are in contact with each other. By setting the contact angle a at 90° or less, the first bead 41 and the second bead 42 can be easily and stably formed, and also copper powder 15 (metal powder) can be easily charged into a trough portion 43 (43a, 43b) formed between each first bead 41 and the corresponding second bead 42 at high density.

Subsequently, in a determination step S14, whether all of beads desired to be formed in the thin film layer 15a have been formed is checked. As described above, in the present embodiment, the irradiation path H includes H1, H2, and H3. Thus, in the irradiation path H3, a bead has not yet been formed. Thus, it is determined “No”, and the process returns to the second laser irradiation step S13. Subsequently, in the second laser irradiation step S13, the near-infrared laser beam L1 (shaping optical beam) is applied to the thin film layer 15a along the irradiation path H3 thereon, whereby a second bead 42 is formed.

In the determination step S14 and the subsequent steps, when a new bead is formed, the second bead 42 that has just been formed is used as a first bead 41, and a bead to be newly formed is considered to be a second bead 42. With this process, the second trough portion 43b (trough portion 43) is formed between the second bead 42 and the first bead 41 (second bead 42), whereby the first layer 15A is completed. If beads have been formed on all irradiation paths, it is determined “Yes”, and the process proceeds to the second step S20.

In the second step S20, copper powder (metal powder) is fed into the trough portions 43a and 43b of the first layer 15A in the irradiation area Ar1. In this process, the metal-powder feeding controller 25 causes the metal-powder feeding device 20 to operate (move upward), whereby the feeding table 24 carrying the metal powder 15 is moved upward by a predetermined height such that the metal powder protrudes (not depicted) from the upper surface of the powder storing container 22.

Subsequently, the recoater 26 returned to the initial position is moved from the right to the left in FIG. 1, whereby the metal powder 15 is fed from the powder storing container 22 to the shaping container 21 to form a powder thin film layer 15b on the first layer 15A on the baseplate 27. At this time, positions of vertices A1, A2, and A3 of the respective first beads 41 and the corresponding second beads 42 included in the first layer 15A, that is, positions of upper ends of the trough portions 43a and 43b, are positioned slightly lower than the upper surface of the powder storing container 22.

The thin film layer 15b is thus formed as depicted in FIG. 10. In other words, the metal powder 15 is fed such that the height h of the thin film layer 15b becomes slightly greater than the depth β of the trough portions 43a and 43b (h>β). Note that the height h of the thin film layer 15b may be equal to the depth β of the trough portions 43a and 43b (h=β). The thin film layer 15b is heated at about 400° C. by the heater 28 via the baseplate 27 and the first layer 15A.

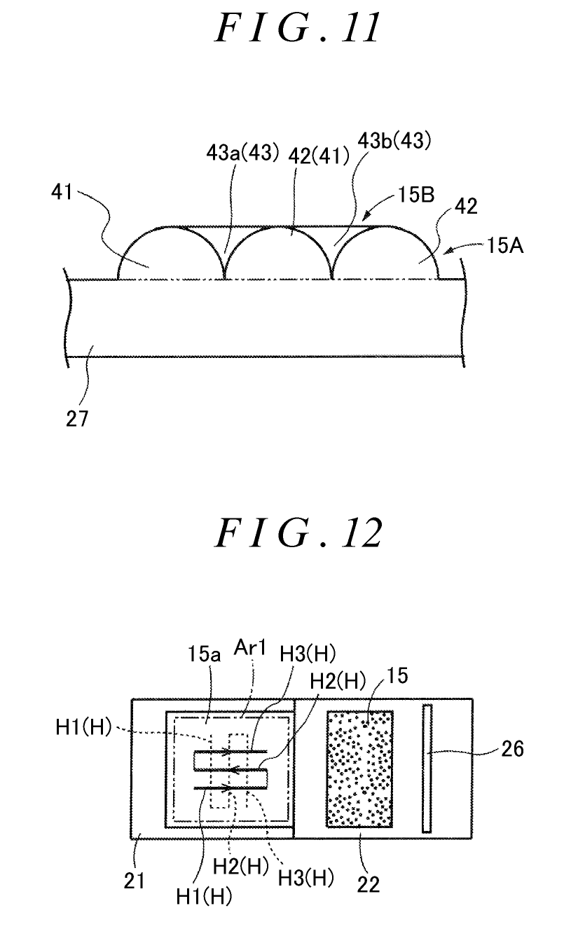

In a third laser irradiation step S31 (third step S30), the shaping unit 70 controls the shaping-optical-beam irradiation device 30 to cause the shaping-optical-beam irradiation device 30 to apply the near-infrared laser beam L1 (shaping optical beam) to the thin film layer 15b along the trough portion 43 (43a) thereon. Thus, the copper powder in the trough portion 43a is heated to be melted, and is then solidified. At this time, the copper powder fed in the trough portion 43a has been fed such that the height thereof becomes greater than the depth β of the trough portion 43a. However, the apparent volume of the copper powder decreases as the copper powder is melted because interstices therein are accordingly filled, and consequently the trough portion 43a becomes fully filled with melted copper (see FIG. 11).

The melted copper is stored in the trough portion 43a before being solidified. Thus, during solidification, even when the melted copper tends to be deformed into a ball shape due to its surface tension γ, such deformation is restricted by inner walls of the trough portion 43a. This prevents the solidified copper from becoming a discontinuous distorted ball shape. Consequently, copper of the first bead 41 and the second bead 42 and copper in the trough portion 43a are integrated together.

Subsequently, in a determination step S32 (third step S30), whether all of the desired irradiation of the trough portion 43 in the thin film layer 15b has been completed is determined. As described above, in the present embodiment, the trough portion 43a and the trough portion 43b are to be irradiated. However, the trough portion 43b has not yet been irradiated. Thus, it is determined “No”, and the process returns to the third laser irradiation step S31.

Subsequently, the near-infrared laser beam L1 is applied to the thin film layer 15b along the trough portion 43b thereon, and the copper powder in the trough portion 43b is heated to be melted, and is then solidified. Thus, the first layer 15A and the second layer 15B are formed, and the respective first beads 41 and the corresponding second beads 42, copper in the trough portion 43a, and copper in the trough portion 43b are integrated together (see FIG. 11). Subsequently, in the determination step S32, it is determined “Yes”, and the process proceeds to a final determination step S41.

In the final determination step S41, whether all of the desired formations of the first layer 15A and the second layer 15B have been completed is determined. Generally, subsequently, a plurality of combined layers each including the first layer 15A and the second layer 15B are formed one on another. However, for convenience of description, description is made assuming that only one more combined layer is to be formed in the present embodiment. Thus, in the final determination step S41, it is determined “No”, and the process returns to the first feeding step S11 (first step S10).

Subsequently, after processes from the first feeding step S11 (first step S10) to the determination step S32 (third step S30) are sequentially performed, it is determined “Yes” in the final determination step S41, and this flowchart is completed. When a series of processes from the first step S10 to the third step S30 are repeatedly performed a plurality of times, among trough portions 43 (43a and 43b) extending in the directions of the predetermined axes corresponding to the respective times, the extending direction of trough portions 43 (43a and 43b) formed in the previous series of processes and the extending direction of trough portions 43 (43a and 43b) formed in a series of processes subsequent to the previous series of processes are arranged in directions that differ by 90°.

In other words, the direction in which the first bead 41 and the second bead 42 formed in the first step S10 extend is changed to a direction that differs by 90° every time the first bead 41 and the second bead 42 are stacked a plurality of times (see the irradiation path H (H1 to H3) indicated by continuous lines in FIG. 12). However, the present invention is not limited to this, and the directions may differ by an optional angle other than 90°. This optional angle may be set to an angle that differs each time. Thus, strength of the additively shaped article (shaped article) is appropriately increased.

In the foregoing, a process of changing the extending direction by 90° or an optional angle every time the first bead 41 and the second bead 42 are stacked is not described in relation to the flowchart. However, as an actual method for this, for example, a counter is provided before the first step S10, and the counter is incremented by one every time the counter is passed through. Control may be performed such that the extending direction of the first bead 41 and the second bead 42 is set at 0° when the count of the counter is an odd number, and such that the extending direction is set at 90° (or an optional angle) when the count is an even number. However, needless to say, this is merely one example, and the control may be performed in any other way.

As described above, in the present embodiment, after the process of the third step S30, the first step S10 of preparing (forming) again the first layer 15A on the shaped article is performed. Subsequently, after the first step S10 that has been performed after the process of the third step S30, the second step S20 and the third step S30 are sequentially and repeatedly performed until the shaped article is completed.

The shaping method according to the first embodiment includes: the first step S10 of forming (preparing), in the irradiation area Ar1 on a baseplate 27, a first layer 15A of a shaped article having on its upper surface a trough portion 43a (43) that is formed in a recessed manner along a predetermined axis; the second step S20 of feeding copper powder (metal powder) to the trough portion 43a (43); and the third step S30 of, after the process of the second step S20, applying the near-infrared laser beam L1 (shaping optical beam) to the copper powder (metal powder) fed to the trough portion 43a (43) to melt the copper powder.

As described above, in the third step S30, the copper powder (metal powder) in the trough portion 43a, 43b irradiated with the near-infrared laser beam L1 is melted in the trough portion 43a, 43b, and is stored in the trough portion 43a, 43b. Thus, even later when heat of the melted copper (melted metal) stored in the trough portion 43a, 43b is transmitted to outside due to its high heat conductivity, and accordingly the temperature of the melted metal decreases significantly and the surface tension γ thereof increases, the melted copper (melted metal) is less likely to form a ball (spherical) shape, and a shaped article having high density can be obtained after solidification.

In the shaping method according to the first embodiment, in order to form (prepare) the first layer 15A, the first step S10 includes: the first feeding step S11 of feeding the copper powder (metal powder) to the irradiation area Ar1 on the baseplate 27; the first laser irradiation step S12 of applying the near-infrared laser beam L1 (shaping optical beam) to the copper powder fed to the irradiation area Ar1 to melt the copper powder, and then solidifying the melted copper powder, thereby forming a first bead 41 that linearly extends in a direction of the irradiation path H1 (direction of the predetermined axis) and has a semicircular shape in its cross-section intersecting the irradiation path H1 (predetermined axis); and the second laser irradiation step S13 of applying the near-infrared laser beam L1 to the copper powder arranged near the first bead 41 among the copper powder (metal powder) fed to the irradiation area Ar1, melting the copper powder, and then solidifying the melted copper powder, thereby forming a second bead 42 that linearly extends in the direction of the irradiation path H2, H3 (direction of the predetermined axis) at a predetermined distance apart from the first bead 41, has a semicircular shape in its cross-section intersecting the irradiation path H2, H3 (predetermined axis), and defines the trough portion 43a, 43b (43) by a space between the first bead 41 and the second bead 42.

As described above, the trough portion 43a, 43b (43) can be defined by the first bead 41 and the second bead 42 formed by irradiation with the near-infrared laser beam L1, and thus the method can be performed easier at a lower cost than the case of forming the trough portion in an additional step.

In the shaping method according to the first embodiment, after the process of the third step S30, the first step S10 of preparing the first layer 15A on the shaped article is performed, and after the first step S10 that has been performed after the process of the third step S30, the second step S20 and the third step S30 are sequentially and repeatedly performed. This enables manufacturing of an additively shaped article having high density.

In the shaping method according to the first embodiment, when a series of processes from the first step S10 to the third step S30 are repeatedly performed, the extending direction of the trough portion 43a, 43b (43) formed in the previous series of processes and the extending direction of the trough portion 43a, 43b (43) formed in a series of processes subsequent to the previous series of processes are different. Thus, a shaped article with anisotropic orientations can be formed, and the strength can be increased.

In the shaping method according to the first embodiment, in the second step S20, the copper powder (metal powder) fed to the trough portion 43a, 43b (43) is fed such that the height h thereof becomes equal to or greater than the depth β of the trough portion 43a, 43b (43). Thus, when the copper powder is melted, interstices in the copper powder are filled with melted copper, whereby the space of the trough portion 43a, 43b (43) can be filled favorably. Consequently, the surface of the second layer 15B can be formed in a planar manner together with the first layer 15A.

In the shaping method according to the first embodiment, the shaping optical beam is a laser beam of a near-infrared wavelength, and the metal powder is copper powder. Copper is a material that has very low absorptance of the laser beam of a near-infrared wavelength (near-infrared laser beam L1) at room temperature. When a material having very low absorptance of the laser beam of a near-infrared wavelength (near-infrared laser beam L1) is used, it is difficult to form a penetrating portion in a member serving as a base by a conventional method, and thus the material tends to form a ball shape due to its surface tension during solidification. However, by the shaping method according to the first embodiment, additive shaping can be easily and favorably performed even with such a material.

In the shaping method according to the first embodiment, before the near-infrared laser beam L1 (shaping optical beam) is applied in the first laser irradiation step S12 (S10) and the second laser irradiation step S13 (S10), the copper powder (metal powder) fed to the irradiation area Ar1 is preheated by the heater 28. Thus, the first bead 41 and the second bead 42 can be more stably formed when being formed through irradiation of the near-infrared laser beam L1 in the first step S10.

In the first embodiment, copper powder is used as the metal powder. However, the present invention is not limited to this, and the metal powder may be aluminum powder as in Modification 1 (not depicted). Like copper powder, aluminum powder has low absorptance of the near-infrared laser beam L1 at room temperature, and also has relatively high heat conductivity. Therefore, effects similar to those with the copper powder can be expected.

In the first embodiment, when a series of processes from the first step S10 to the third step S30 are repeatedly performed a plurality of times, the extending direction of trough portions 43 (43a and 43b) formed in the previous series of processes and the extending direction of trough portions 43 (43a and 43b) formed in a series of processes subsequent to the previous series of processes are arranged in directions that differ (by 90° for example). However, the present invention is not limited to this, and as in Modifications 2 and 3, the extending direction of trough portions 43 (43a and 43b) formed in the previous series of processes and the extending direction of trough portions 43 (43a and 43b) formed in a series of processes subsequent to the previous series of processes may be the same.

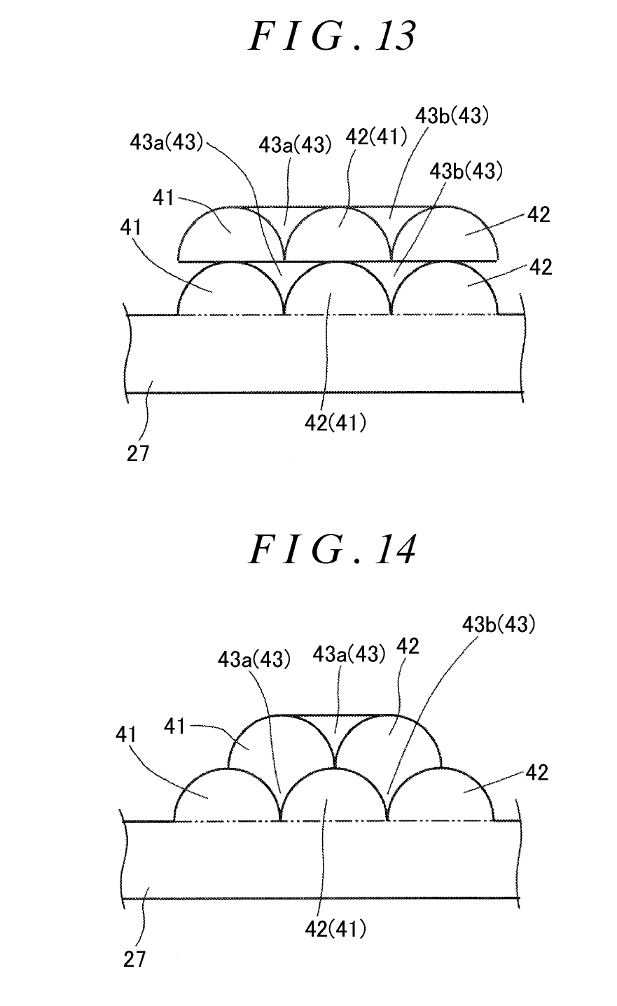

As depicted in FIG. 13, in Modification 2, on the respective first beads 41 and the corresponding second beads 42 in the first layer, the respective first beads 41 and the corresponding second beads 42 in the second layer are stacked to form a shaped article. In this case, as described above, the copper powder 15 is fed to the trough portions 43a and 43b (43) in the second step S20 in each of the first layer (lower layer) and the second layer (upper layer) after the respective first beads 41 and the corresponding second beads 42 are formed. Subsequently, in the third step S30, the copper powder 15 in the trough portions 43a and 43b (43) are irradiated with the near-infrared laser beam L1 to be melted, and is then solidified to form each layer.

As depicted in FIG. 14, in Modification 3, between the respective first beads 41 and the corresponding second beads 42 in the first layer, that is, on the trough portions 43a and 43b in the first layer, the first bead 41 and the second bead 42 are stacked to form a shaped article. In the case of Modification 3, the copper powder 15 is fed to the trough portions 43a and 43b (43) in the second step S20. Subsequently, in the third step S30, the copper powder 15 in the trough portions 43a and 43b (43) is irradiated with the near-infrared laser beam L1 to be melted, and is then solidified, whereby filling of the trough portions 43a and 43b (43) in the first layer and formation of the first bead 41 and the second bead 42 in the second layer are performed simultaneously.

Because filling of the trough portions 43a and 43b (43) and formation of the first bead 41 and the second bead 42 can thus be performed simultaneously, man-hours for manufacturing can be significantly reduced. In Modification 3, for the uppermost layer in stacking, the copper powder 15 is fed to the trough portions 43a and 43b (43) in the second step S20 in the same manner as in the first embodiment. Subsequently, in the third step S30, the copper powder 15 in the trough portions 43a and 43b (43) may be irradiated with the near-infrared laser beam L1 to be melted, and may be then solidified, whereby the upper surface of the shaped article may be formed so as to be flush with the upper ends of the trough portions 43a and 43b (43).

In the first embodiment, the thin film layers 15a and 15b are preheated by the heater 28 provided between the baseplate 27 and the upper surface of the shaped-article lifting table 23. However, the present invention is not limited to this, and as in Modification 4 (not depicted), the preheating may be performed by applying the near-infrared laser beam L1 (shaping optical beam) to portions of the metal powder included in the respective thin film layers 15a and 15b that are irrelevant to formation of a shaped article to heat the thin film layers. In this case, irradiation output of the near-infrared laser beam L1 only needs to be reduced to or below such an output that does not melt the metal powder. In this case also, similar effects can be expected.

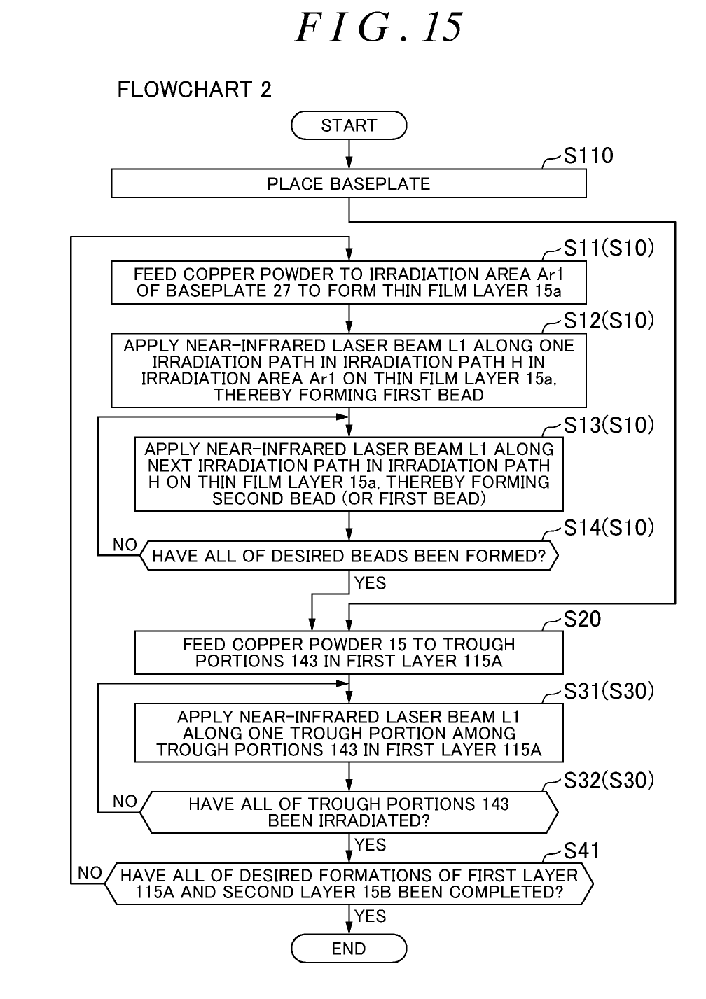

The following describes a shaping method according to a second embodiment with reference to the flowchart 2 in FIG. 15. The second embodiment is different from the first embodiment only in the first step S10 in the shaping method. Thus, only different points will be described, and description of like points is omitted. In the first embodiment, in the first step S10, the first bead 41 and the second bead 42 are formed parallel to each other with a predetermined distance therebetween through irradiation with the near-infrared laser beam L1 (shaping optical beam). The trough portions 43a and 43b (43) are defined by the spaces between the respective first beads 41 and the corresponding second beads 42. The first layer 15A is prepared (formed) in this manner.

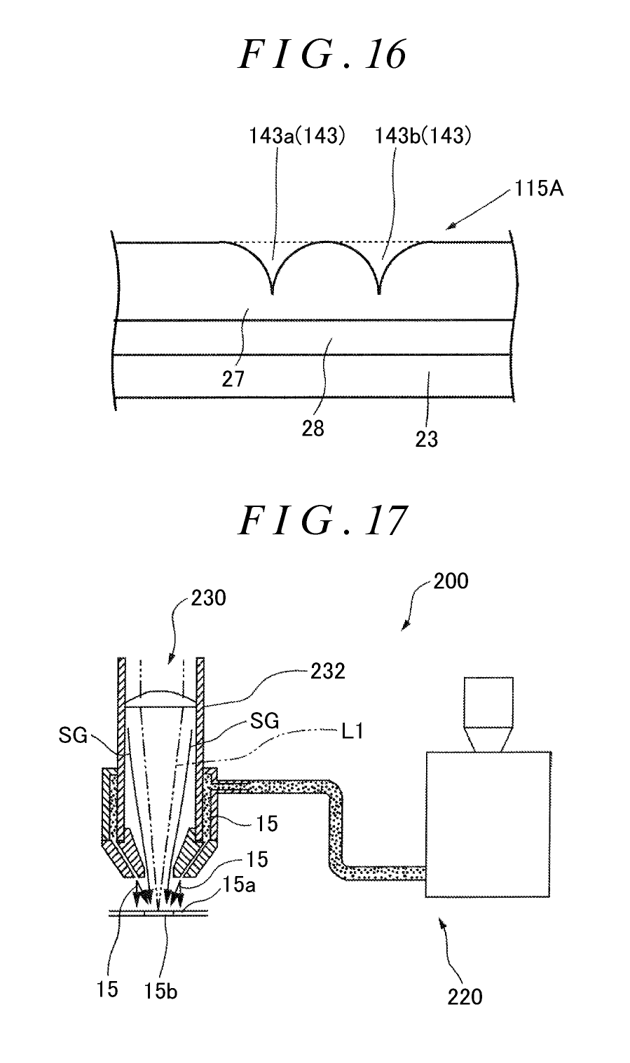

However, as depicted in FIG. 15, in the first step S110 in the second embodiment, a first layer 115A formed in advance in an additional step is prepared by being placed onto the upper surface of the shaped-article lifting table 23 by a worker. Specifically, as depicted in FIG. 16, on the surface of the baseplate 27, trough portions 143a and 143b (143) having the same shapes of those of the trough portions 43a and 43b (43) described in the first embodiment are formed (formed in a recessed manner) by common machining, and the baseplate is placed on the upper surface of the shaped-article lifting table 23.

At this time, the baseplate 27 provided with the heater 28 at its lower surface is placed on the upper surface of the shaped-article lifting table 23 such that the trough portions 143a and 143b (143) face upward. In other words, the first layer 115A is formed on the baseplate 27 integrally with the baseplate 27, and is thus prepared. Note that when the processes of the first step S110, the second step S20, and the third step S30 are repeatedly performed, in the second round and after, the trough portions 143a and 143b (143) are preferably formed by the same steps (S11 to S14) as the first step S10 in the first embodiment.

Instead of the additively shaping device 100 used in the first and second embodiments, the present invention may be applied to an additively shaping device 200 (see FIG. 17) that additively shapes copper powder in the atmosphere without a chamber, as a third embodiment. The additively shaping device 200 is a well-known additively shaping device using what is called laser metal deposition (LMD).

The additively shaping device 200 integrally includes a metal-powder feeding device 220 corresponding to the metal-powder feeding device 20 on the outer-peripheral side of a laser head 232 that emits a laser beam. In the additively shaping device 200, copper powder 15 (metal powder) is injected from an outer-peripheral portion of the laser head 232 into the irradiation area Ar1 by the metal-powder feeding device 220, and then the near-infrared laser beam L1 (shaping optical beam) is applied to the copper powder 15 (metal powder) in the irradiation area Ar1.

At the same time as the near-infrared laser beam L1 is applied, shielding gas SG (e.g., nitrogen gas) is injected from the inner-peripheral side of the laser head 232 into the irradiation area Ar1, whereby the copper powder 15 is prevented from being oxidized when being melted. With this configuration, a first layer (not depicted) having trough portions 43a and 43b (43) that is similar to those of the first layer 15A (see FIG. 7 and FIG. 8) prepared (formed) in the first embodiment is prepared in the irradiation area Ar1 on the baseplate (first step).

Subsequently, a second step of injecting copper powder 15 (metal powder) from the outer-peripheral portion of the laser head 232 into the irradiation area Ar1 to feed the copper powder (metal powder) into the trough portions 43a and 43b (43) and a third step of, after the second step, applying the near-infrared laser beam L1 (shaping optical beam) and injecting the shielding gas SG to the metal powder fed to the trough portions 43a and 43b (43) to melt the metal powder are performed. Also with the additively shaping device 200 according to the third embodiment as described above, effects similar to those in the first embodiment can be obtained.

With the additively shaping devices 100 and 200 according to the first and second embodiments, a shaped article having high density similar to the shaped article manufactured by the shaping method according to the above-described embodiments can be stably manufactured.

What is claimed is:

1. A shaping method using an additively shaping device that additively shapes a shaped article by melting metal powder through irradiation with a shaping optical beam and then solidifying the melted metal powder,
the additively shaping device including:
a metal-powder feeding device that feeds the metal powder to an irradiation area of the shaping optical beam; and
a shaping-optical-beam irradiation device that applies the shaping optical beam to a predetermined position of the metal powder fed to the irradiation area while being isolated from outside air, and
the shaping method comprising:
a first step of preparing, in the irradiation area on a baseplate, a first layer of the shaped article having on an upper surface of the first layer a trough portion that is formed in a recessed manner along a predetermined axis;
a second step of feeding the metal powder to the trough portion; and
a third step of, after the second step, applying the shaping optical beam to the metal powder fed to the trough portion to melt the metal powder.

2. The shaping method using an additively shaping device according to claim 1, wherein
in order to prepare the first layer, the first step includes:
a first feeding step of feeding the metal powder to the irradiation area on the baseplate;
a first laser irradiation step of applying the shaping optical beam to the metal powder fed to the irradiation area to melt the metal powder, and then solidifying the melted metal powder, thereby forming a first bead that linearly extends in a direction of the predetermined axis and has a semicircular shape in a cross-section of the first bead intersecting the predetermined axis; and
a second laser irradiation step of applying the shaping optical beam to the metal powder arranged near the first bead among the metal powder fed to the irradiation area, melting the metal powder, and then solidifying the melted metal powder, thereby forming a second bead that linearly extends in the direction of the predetermined axis at a predetermined distance apart from the first bead, has a semicircular shape in a cross-section of the second bead intersecting the predetermined axis, and defines the trough portion by a space between the first bead and the second bead.

3. The shaping method using an additively shaping device according to claim 2, wherein
after the third step, the first step of preparing the first layer on the shaped article is performed, and after the first step that has been performed after the third step, the second step and the third step are sequentially and repeatedly performed.

4. The shaping method using an additively shaping device according to claim 3, wherein
when a series of processes from the first step to the third step are repeatedly performed, an extending direction of the trough portion formed in the previous series of processes and an extending direction of the trough portion formed in a series of processes subsequent to the previous series of processes are different.

5. The shaping method using an additively shaping device according to claim 1, wherein
in the second step, the metal powder fed to the trough portion is fed such that a height of the metal powder is equal to or greater than a depth of the trough portion.

6. The shaping method using an additively shaping device according to claim 1, wherein
the shaping optical beam is a laser beam of a near-infrared wavelength, and
the metal powder is copper powder or aluminum powder.

7. The shaping method using an additively shaping device according to claim 2, wherein
before the shaping optical beam is applied in the first laser irradiation step and the second laser irradiation step, preheating is performed on the metal powder fed to the irradiation area.

8. The shaping method using an additively shaping device according to claim 7, wherein
the preheating is performed by a heater provided on a side opposite to a side irradiated with the shaping optical beam.

9. The shaping method using an additively shaping device according to claim 7, wherein
the preheating is performed by irradiating the metal powder with the shaping optical beam having an output that is reduced so as not to melt the metal powder.

10. The shaping method using an additively shaping device according to claim 1, wherein
in the first layer of the shaped article prepared on the baseplate in the first step, the trough portion is formed in a recessed manner on the surface of the baseplate by machining.

11. An additively shaping device that additively shapes a shaped article by melting metal powder through irradiation with a shaping optical beam and then solidifying the melted metal powder, the additively shaping device comprising:
a metal-powder feeding device that feeds the metal powder to an irradiation area of the shaping optical beam;
a shaping-optical-beam irradiation device that applies the shaping optical beam to a predetermined position of the metal powder fed to the irradiation area while being isolated from outside air; and
a control device that controls the metal-powder feeding device and the shaping-optical-beam irradiation device; wherein
the control device includes:
a metal-powder feeding controller that controls the metal-powder feeding device to cause the metal-powder feeding device to feed the metal powder to a trough portion of a first layer of the shaped article that is prepared in the irradiation area on a baseplate, the trough portion being formed on an upper surface of the first layer in a recessed manner along a predetermined axis; and
a shaping-optical-beam irradiation controller that, after the metal powder is caused to be fed to the trough portion by the metal-powder feeding controller, controls the shaping-optical-beam irradiation device to cause the shaping-optical-beam irradiation device to apply the shaping optical beam to the metal powder fed to the trough portion to melt the metal powder.
